(19) United States
(12) Patent Application Publication
(10) Pub. No.: US 2019/0064531 A1
(43) Pub. Date: Feb. 28, 2019

(54) VEHICLE DISPLAY DEVICE AND DISPLAY CONTROL METHOD

(71) Applicant: Yazaki Corporation, Tokyo (JP)

(72) Inventors: Tomotake WAKATSUKI, Shizuoka (JP); Kazuyoshi OGASAWARA, Shizuoka (JP)

(73) Assignee: Yazaki Corporation, Tokyo (JP)

(21) Appl. No.: 16/110,087

(22) Filed: Aug. 23, 2018

(30) Foreign Application Priority Data
Aug. 29, 2017 (JP) 2017-163941

(51) Int. Cl. G02B 27/01; G06K 9/00; G08G 1/0968; G09G 5/38

(52) U.S. Cl. CPC G02B 27/0179; G02B 27/0101; G06K 9/00798; G06K 9/00845; G08G 1/096861; G06T 7/70; G02B 2027/0141; G02B 2027/0187; G02B 2027/0138; G06K 2209/23; G09G 5/38

(57) ABSTRACT

A vehicle display device includes a vehicle front side camera that acquires a front area image, an image analyzing unit that detects a position of white lines and a position of a preceding vehicle in a case in which there is the preceding vehicle on a lane from the front area image, and a controller that sets a drawing area on the lane on the basis of the position of the white lines or the position of the white lines and the position of the preceding vehicle and draws an information image including route guidance information in the drawing area on the basis of the shape of the drawing area.

### CROSS-REFERENCE TO RELATED APPLICATION(S)

The present application claims priority to and incorporates by reference the entire contents of Japanese Patent Application No. 2017-163941 filed in Japan on Aug. 29, 2017.

### BACKGROUND OF THE INVENTION

### 1. Field of the Invention

The present invention relates to a vehicle display device and a display control method.

### 2. Description of the Related Art

Conventionally, head-up display devices which are installed in vehicles such as automobiles and project a display image from a display device onto a windshield and cause a driver to visually recognize the display image superimposed on a real landscape have been provided.

For example, a navigation device that decides a priority of an obstacle or the like which is not to be overlooked by the driver when guidance information is displayed superimposed on a real landscape, and decides a display position and a display method of the guidance information so that conspicuousness of an obstacle with a higher priority than the guidance information is not remarkably lowered is disclosed in Japanese Patent Application Laid-open No. JP 2006-162442.

However, in the technique disclosed in JP 2006-162442 A, since the display position and the display method of the guidance information are changed while the vehicle is traveling, it is necessary for the driver to search for the guidance information displayed on the windshield, and there is room for improvement.

### SUMMARY OF THE INVENTION

It is an object of the present invention to provide a vehicle display device and a display control method which are capable of fixedly displaying information to be informed to the driver at a position at which the driver is constantly looking.

A vehicle display device according to one aspect of the present invention includes an image display unit that projects a display image in front of a driver of a vehicle and causes the display image to be displayed superimposed on a real landscape in front of the vehicle, a front area image acquiring unit that captures the real landscape in front of the vehicle and acquires a front area image; a white line detecting unit that detects a position of a pair of colored lines sandwiching a lane extending to an area in front of the vehicle and a position of a preceding vehicle in a case in which there is a preceding vehicle on the lane from the front area image; a drawing area setting unit that sets a drawing area on the lane on the basis of the positions of the pair of colored lines or the positions of the pair of colored lines and the position of the preceding vehicle; and a drawing unit that draws an information image including route guidance information to be informed to the driver in the drawing area on the basis of a shape of the drawing area, wherein the drawing unit transforms the information image in accordance with a change in a shape of the drawing area in the display image.

According to another aspect of the present invention, in the vehicle display device, it is preferable that the drawing area setting unit sets the drawing area in an area extending on the lane from the area in front of the vehicle along the colored line without overlapping the preceding vehicle on the basis of coordinates indicating the position of the colored line in the front area image or coordinates indicating the position of the colored line in the front area image and coordinates indicating the position of the preceding vehicle.

According to still another aspect of the present invention, in the vehicle display device, it is preferable that the vehicle display device further includes a driver image acquiring unit that captures the driver and acquires a driver image; and an eye point detecting unit that detects a position of an eye point of the driver from the driver image, wherein the drawing unit adjusts the position of the drawing area in the display image in accordance with the position of the eye point.

In a display control method according to still another aspect of the present invention, a vehicle display device includes an image display unit that projects a display image in front of a driver of a vehicle and causes the display image to be displayed superimposed on a real landscape in front of the vehicle, and the display control method includes a front area image acquisition step of capturing the real landscape in front of the vehicle and acquiring a front area image; a white line detection step of detecting a position of a pair of colored lines sandwiching a lane extending to an area in front of the vehicle and a position of a preceding vehicle in a case in which there is a preceding vehicle on the lane from the front area image; a drawing area setting step of setting a drawing area on the lane on the basis of the positions of the pair of colored lines or the positions of the pair of colored lines and the position of the preceding vehicle; and a drawing step of drawing an information image including route guidance information to be informed to the driver in the drawing area on the basis of a shape of the drawing area, wherein the drawing step includes transforming the information image in accordance with a change in a shape of the drawing area in the display image.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of a vehicle display device according to an embodiment;

FIG. 2 is a block diagram of the vehicle display device according to the embodiment;

FIG. 3 is a flowchart illustrating an operation example of the vehicle display device according to the embodiment;

FIG. 4 is an explanatory diagram for describing white line detection of a front area image according to the embodiment;

FIGS. 5A and 5B are explanatory diagrams for describing white line detection of a front area image according to the embodiment;

FIG. 6 is an explanatory diagram of white line detection and preceding vehicle detection of a front area image according to the embodiment;

FIG. 7 is an explanatory diagram of eye point detection of a driver image according to the embodiment;

FIG. 8 is an explanatory diagram of conversion from a front area image to a display image according to the embodiment; and

FIG. 9 is an explanatory diagram of a display image displayed in a drawing area according to the embodiment.

### DETAILED DESCRIPTION OF THE PREFERRED EMBODIMENTS

Hereinafter, exemplary embodiments of a vehicle display device and a display control method according to the present invention will be described in detail with reference to the appended drawings. The present embodiment is not limited by the following embodiments. In addition, constituent elements in the following embodiments include those which can be easily replaced by those skilled in the art or are substantially the same.

### EMBODIMENT

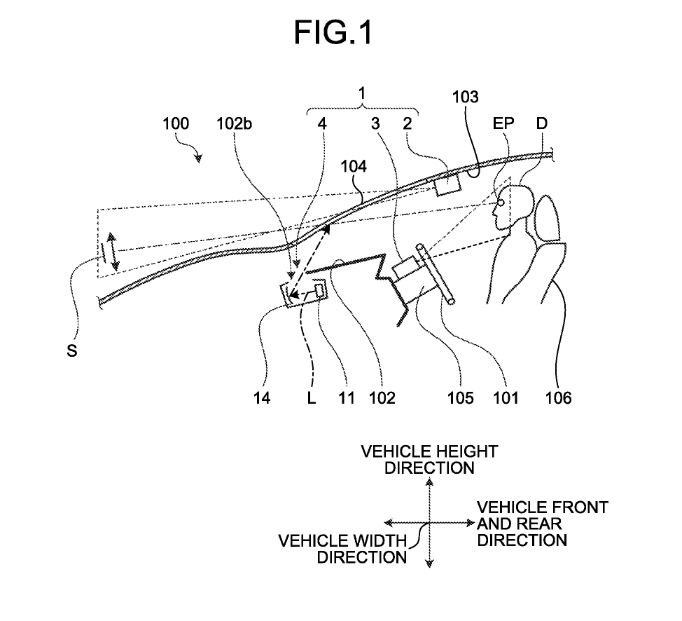

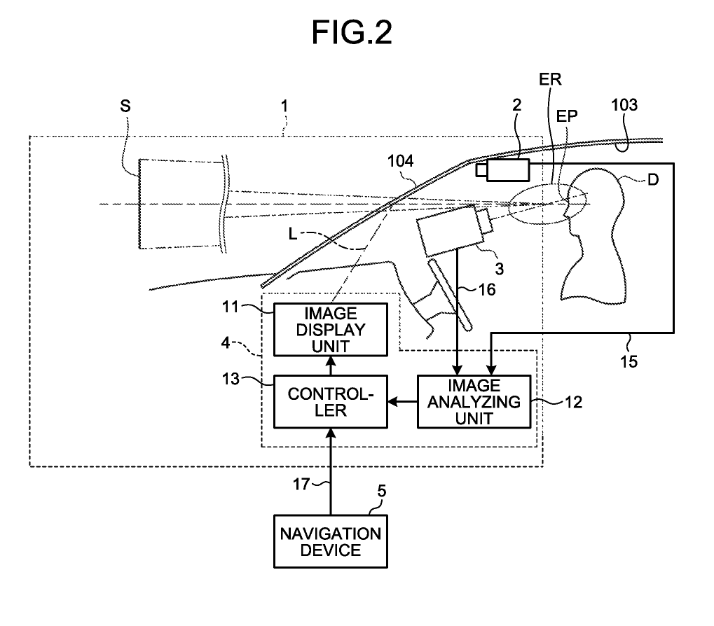

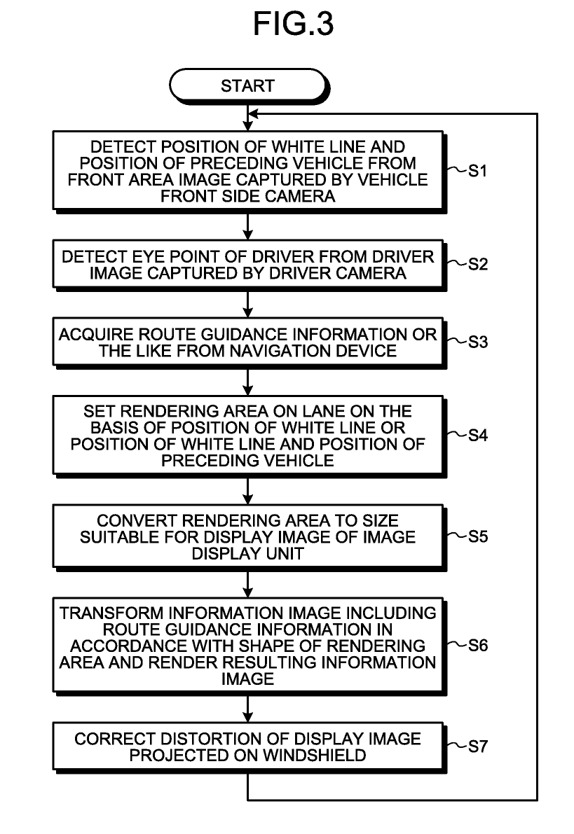

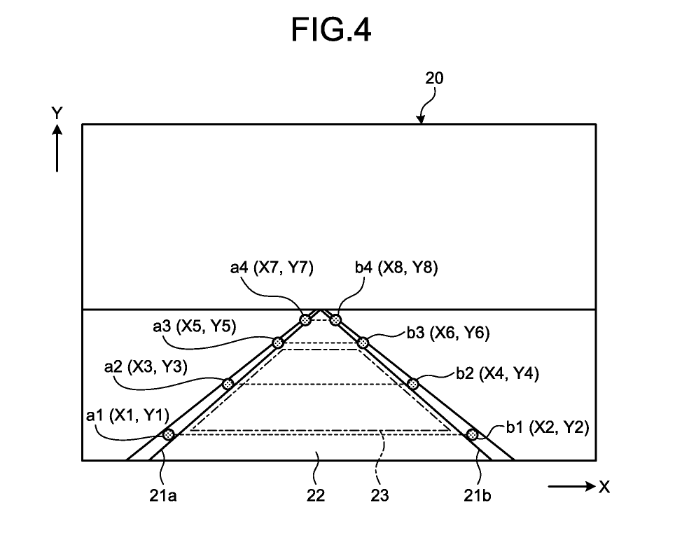

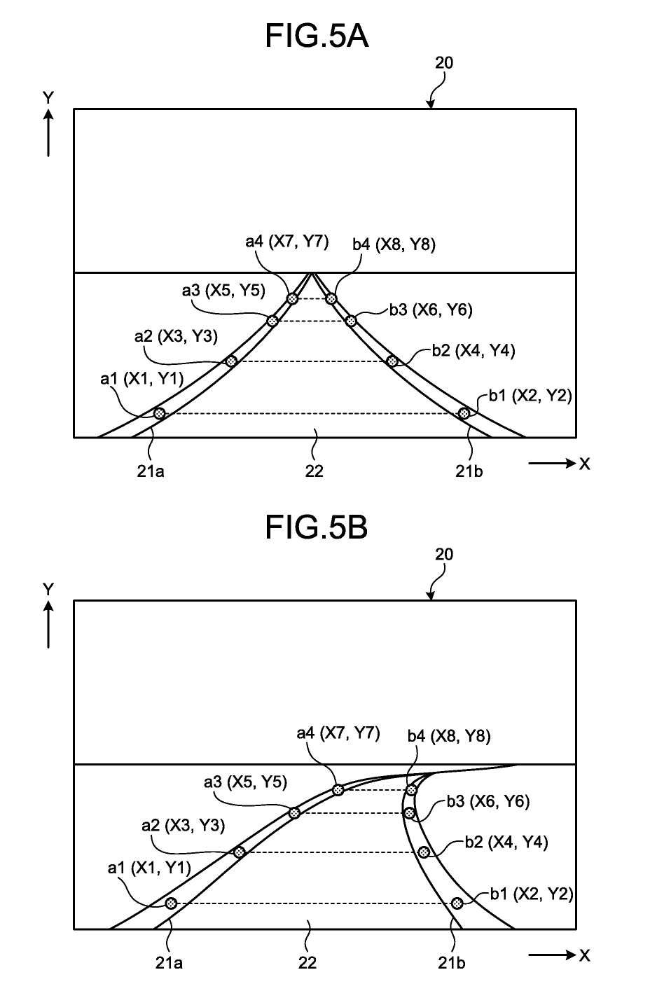

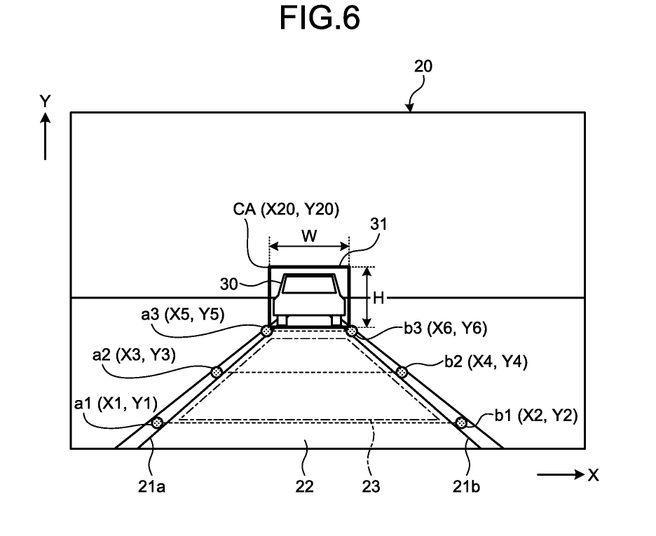

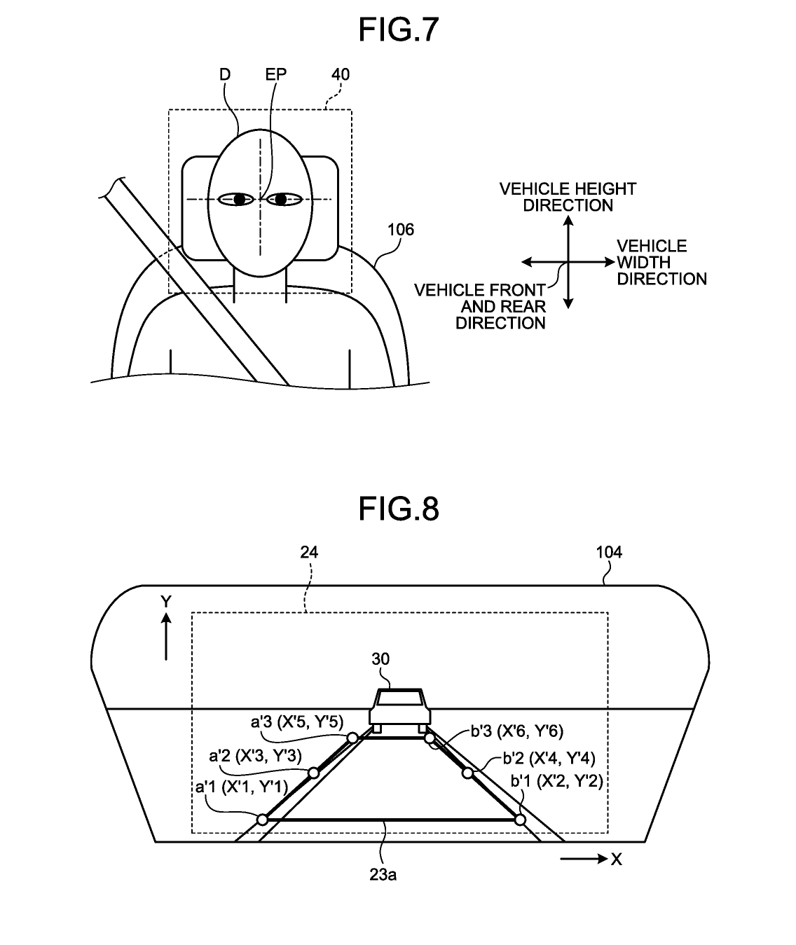

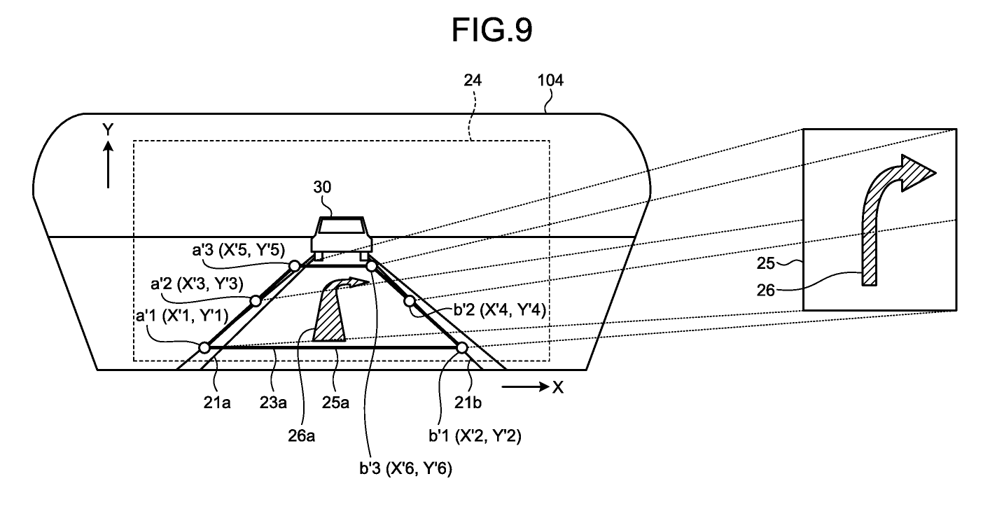

FIG. 1 is a schematic configuration diagram of a vehicle display device according to an embodiment. FIG. 2 is a block diagram of the vehicle display device according to the embodiment. FIG. 3 is a flowchart illustrating an operation example of the vehicle display device according to the embodiment. FIG. 4 is an explanatory diagram for describing white line detection of a front area image according to the embodiment. FIGS. 5A and 5B are explanatory diagrams for describing white line detection of a front area image according to the embodiment. FIG. 6 is an explanatory diagram for describing white line detection and preceding vehicle detection of a front area image according to the embodiment. FIG. 7 is an explanatory diagram of eye point detection of a driver image according to an embodiment. FIG. 8 is an explanatory diagram of conversion from a front area image to a display image according to an embodiment. FIG. 9 is an explanatory diagram of a display image displayed in a drawing area according to an embodiment. The front area image illustrated in FIG. 4 is an image captured on a flat road. The front area image illustrated in FIG. 5A is an image captured on a sloping road, and the front area image illustrated in FIG. 5B is an image captured on a road bent in a curved shape to the right.

As illustrated in FIGS. 1 and 2, a vehicle display device 1 according to the present embodiment is, for example, a head up display (HUD) device installed in a vehicle 100 such as automobile. A vehicle display device 1 projects a display image onto an area in front of a driver D of a vehicle 100 and causes the display image to be displayed superimposed on a real landscape in front of the vehicle. The display image is projected onto a display range 24 (see FIG. 8) on the windshield 104. The display image includes information images 25 and 25a (see FIG. 9) to be informed to the driver D. The information image 25 is an original image before being transformed in accordance with a shape of a drawing area 23a to be described later. The information image 25a is an image which is transformed in accordance with the shape of the drawing area 23a. The information image 25 indicates, for example, route guidance information or the like. The route guidance information includes a turning direction of the vehicle 100, a distance to a turn, a landmark, lane information, and the like. As the information image 25 of the route guidance information, for example, there is an arrow of a turning direction. The vehicle display device 1 projects the display image onto a windshield 104 and causes a virtual image S to be displayed in front of the driver D of the vehicle 100. The virtual image S is an image to be viewed on an eye point EP of the driver D. The windshield 104 has semi-transparency and reflects laser light L incident from the vehicle display device 1 toward an eye point EP. The eye point EP is a viewpoint position of a driver D sitting on a driving seat 106 of the vehicle 100. The eye point EP indicates, for example, a part between the eyes of the driver D (between the eyebrows). The eye point EP is preset to be located in a so-called ear range ER in the vehicle 100. Here, the ear range ER is a “driver ear range of an automobile” and corresponds to an area in which a predetermined viewpoint of the driver D is positioned in accordance with the vehicle 100. The ear range ER is a statistical representation of a distribution of the positions of the eyes of the driver D in the vehicle 100 and corresponds to, for example, a region in which the positions of the eyes of a predetermined percentage (for example, 95%) of the driver D are included in a state in which the driver D is sitting on the driving seat 106. The driver D recognizes an image reflected by the windshield 104 as a virtual image S. The driver D recognizes the virtual image S as if the virtual image S is positioned in front of the windshield 104. The vehicle display device 1 is assumed to be started together with the start of the vehicle 100 (for example, when an ignition switch is turned on) and stopped with the stop of the vehicle 100 (for example, when the ignition switch is turned off), but the present embodiment is not limited thereto. Specifically, the vehicle display device 1 includes a vehicle front side camera 2, a driver camera 3, and a vehicle display device main body 4.

The vehicle front side camera 2 is a front area image acquiring unit, and acquires front area images 20 (see FIG. 4 or the like) which are images of an area in front of a vehicle 100 by sequentially capturing the real landscape in front of the vehicle 100. The vehicle front side camera 2 is arranged in a passenger compartment of the vehicle 100. The vehicle front side camera 2 is arranged, for example, in a roof 103 in the passenger compartment of the vehicle 100. The vehicle front side camera 2 may be installed on a rearview mirror (not illustrated) arranged on the roof 103. The vehicle front side camera 2 is installed to capture an area in front of the vehicle 100 through the windshield 104. As illustrated in FIG. 8, the imaging range by the vehicle front side camera 2 is set to be able to capture at least a white line drawn on the road and a preceding vehicle 30 traveling in front of the vehicle 100. The vehicle front side camera 2 is connected to the vehicle display device main body 4 via a communication line 15. The vehicle front side camera 2 sequentially outputs the captured images to the vehicle display device main body 4 as the front area image 20 via the communication line 15. The output image also includes a moving image.

The driver camera 3 is a driver image acquiring unit and sequentially captures the driver D and acquires a driver image 40 (see FIG. 7) which is an image of the driver D. The driver camera 3 is arranged in front of the driver D in the compartment of the vehicle 100. The driver camera 3 is arranged, for example, on the top of a steering column 105 and behind a steering wheel 101 when viewed from the driver D. The driver camera 3 is installed to capture at least the eye point EP of the driver D. As illustrated in FIG. 7, the imaging range by the driver camera 3 is decided so that at least the face part including both eyes of the driver D can be captured. The driver camera 3 is connected to the vehicle display device main body 4 via a communication line 16. The driver camera 3 sequentially outputs the captured images to the vehicle display device main body 4 as the driver image 40 via the communication line 16. The output image also includes a moving image.

The vehicle display device main body 4 projects the display image by radiating the laser light L toward the windshield 104 and causes the virtual image S to be displayed in front of the driver D. The vehicle display device main body 4 is arranged inside an instrument panel 102 of the vehicle 100. An opening 102b is formed on the upper surface of the instrument panel 102. The vehicle display device main body 4 projects the display image by radiating the laser light L toward the windshield 104 through the opening 102b. As illustrated in FIG. 2, the vehicle display device main body 4 includes an image display unit 11, an image analyzing unit 12, and a controller 13.

The image display unit 11 is an image display unit and has a function of projecting the display image onto an area in front of the driver D of the vehicle 100 and causing the display image to be displayed superimposed on the real landscape in front of the vehicle. The image display unit 11 causes the virtual image S to be displayed superimposed on the real landscape in front of the vehicle on the basis of the information from the controller 13. The image display unit 11 is, for example, a liquid crystal display device such as a thin film transistor-liquid crystal display (TFT-LCD). The image display unit 11 includes a liquid crystal display unit (not illustrated) and a backlight (not illustrated). The liquid crystal display unit displays an arbitrary image, for example, a color image. The backlight radiates light from the back side of the liquid crystal display unit and projects the image displayed on the liquid crystal display unit toward a reflective mirror 14. The reflective mirror 14 reflects the image projected from the image display unit 11 toward the windshield 104. The image which is reflected and projected by the reflective mirror 14 is reflected toward the driver D by the windshield 104. The image reflected by the windshield 104 is formed as the virtual image S at a position in front of the windshield 104 when viewed from the driver D.

The image analyzing unit 12 is a white line detecting unit and has a function of detecting positions of a pair of white lines 21a and 21b sandwiching a lane 22 extending to the area in front of the vehicle from the front area image 20 illustrated in FIG. 4. The position of the white lines 21a and 21b are indicated by, for example, coordinates on a plane set in the front area image 20. The lane 22 is a region sandwiched between a pair of white lines 21a and 21b extending to the area in front of the vehicle 100 in the front area image 20. Therefore, the lane 22 is specified by the position of the white lines 21a and 21b. The image analyzing unit 12 is a preceding vehicle detecting unit, and has a function of detecting the position of the preceding vehicle 30 in a case in which there is a preceding vehicle 30 on the lane 22 from the front area image 20 illustrated in FIG. 6. The position of the preceding vehicle 30 is indicated by, for example, coordinates in the front area image 20, a height H of the preceding vehicle 30, and a width W of the preceding vehicle 30. The image analyzing unit 12 may be configured to detect the position of the preceding vehicle 30 using an advanced driver assistance system.

The image analyzing unit 12 is an eye point detecting unit and has a function of detecting the position of the eye point EP of the driver D from the driver image 40. For example, the position of the eye point EP is indicated by three-dimensional orthogonal coordinates set in the vehicle 100. The coordinates indicating the position of the eye point EP may include the position in a vehicle width direction of the vehicle 100 and the position in a vehicle height direction and may further include the position in a vehicle longitudinal direction. The position of the eye point EP may be calculated not only by the image analyzing unit 12 but also by the controller 13.

The controller 13 is a drawing area setting unit and has a function of setting a drawing area 23 on the lane 22 on the basis of the positions of a pair of white lines 21a and 21b or the positions of a pair of white lines 21a and 21b and the position of the preceding vehicle 30. The drawing area 23 is an area in which the information image 25 including the route guidance information to be informed to the driver D is drawn and is set on the lane 22. The route guidance information is obtained from a navigation device 5 to be described later. Since there may be a preceding vehicle 30 on the lane 22, the drawing area 23 is set on the basis of the position of the white lines 21a and 21b in the front area image 20 or the position of the white lines 21a and 21b in the front area image 20 and the position of the preceding vehicle 30. The drawing area 23 is indicated by an area which does not overlap with the preceding vehicle 30 and extends on the lane 22 from an area in front of the vehicle 100 along the white lines 21a and 21b. The controller 13 is a drawing unit and has a function of drawing the information image 25 including the route guidance information in the drawing area 23. The controller 13 is, for example, a computer having a central processing unit (CPU), a memory, various kinds of interfaces, and the like and controls the vehicle front side camera 2, the driver camera 3, the image display unit 11, and the image analyzing unit 12. The controller 13 is communicably connected to the vehicle front side camera 2, the driver camera 3, the image display unit 11, and the navigation device 5. The controller 13 acquires route guidance information from the navigation device 5 and determines whether or not the route guidance information can be displayed. The controller 13 may be configured integrally with the image display unit 11 and the image analyzing unit 12.

The navigation device 5 is a so-called car navigation system and is a device that provides the position of its own vehicle or detailed map information of surrounding areas to the passenger of the vehicle 100 including the driver D and gives route guidance to the destination. The navigation device 5 acquires the position of its own vehicle on the basis of information from Global Positioning System (GPS) satellites or the like. Further, the navigation device 5 reads the map information, the route guidance information, or the like from an internal memory or acquires the map information, the route guidance information, or the like from the outside through communication. The navigation device 5 is connected to the controller 13 via a communication line 17 and outputs the acquired route guidance information to the controller 13 via the communication line 17.

Next, an operation of the vehicle display device 1 will be described with reference to FIGS. 3 to 9.

In FIG. 3, in Step S1, the image analyzing unit 12 acquires the front area image 20 captured by the vehicle front side camera 2, and performs white line detection and preceding vehicle detection on the basis of the front area image 20. The image analyzing unit 12 performs only the white line detection in a case in which the preceding vehicle 30 is not present on the lane 22, and the preceding vehicle 30 is unable to be detected. The image analyzing unit 12 acquires the coordinates indicating the positions of the white lines 21a and 21b in the front area image 20 through the white line detection. The coordinates indicating the position of the white line 21a (hereinafter also referred to as “coordinates of the white line 21a”) are indicated by, for example, a1 (X1, Y1), a2 (X3, Y3), a3 (X5, Y5), and a4 (X7, Y7) as illustrated in FIGS. 4, 5A and 5B. On the other hand, the coordinates indicating the position of the white line 21b (hereinafter also referred to as “coordinates of the white line 21b”) are indicated by b1 (X2, Y2), b2 (X4, Y4), b3 (X6, Y6), and b4 (X8, Y8). In a case in which there is a preceding vehicle 30 on the lane 22, using the preceding vehicle detection, as illustrated in FIG. 6, the image analyzing unit 12 acquires coordinates CA (X20, Y20) indicating the position of the preceding vehicle 30, the height H of the preceding vehicle 30, and the width W of the preceding vehicle 30. The coordinates CA indicating the position of the preceding vehicle 30 (hereinafter also referred to as “coordinates of the preceding vehicle 30”) are coordinate of an upper left corner of a rectangular region 31 illustrated in FIG. 6, but the present embodiment is not limited thereto. The region 31 is specified by the coordinates CA, the height H, and the width W.

In Step S2, the image analyzing unit 12 acquires the driver image 40 captured by the driver camera 3 and detects the eye point of the driver D from the driver image 40. The image analyzing unit 12 acquires the coordinates indicating the position of the eye point EP of the driver D through the eye point detection.

In Step S3, the controller 13 acquires the route guidance information or the like from the navigation device 5. The controller 13 determines whether or not the acquired route guidance information is displayed. For example, in a case in which the route guidance information acquired from the navigation device 5 indicates that a distance to an intersection is a predetermined value (for example, 40 m), the controller 13 starts a display by turn-by-turn, or in a case in which a speed limit is switched, the controller 13 starts a display.

In Step S4, the controller 13 sets the drawing area 23 on the lane 22 on the basis of the position of the white lines 21a and 21b or the position of the white lines 21a and 21b and the position of the preceding vehicle 30 as illustrated in FIG. 6. More specifically, the controller 13 sets the drawing area 23 in an area which extends on the lane 22 from the area in front of the vehicle 100 along the white lines 21a and 21b without overlapping the preceding vehicle 30 on the basis of the coordinates of the white lines 21a and 21b in the front area image 20, the coordinates of the white lines 21a and 21b in the front area image 20, and the coordinates indicating the position of the preceding vehicle 30. In a case in which there is no preceding vehicle 30 on the lane 22, and the drawing area 23 is set from the coordinates of the white lines 21a and 21b, the controller 13 sets the drawing area 23 to have a predetermined size. It is preferable that the size of the predetermined drawing area 23 be a size in which the conspicuousness of the information image 25a drawn in the drawing area 23a is considered.

In Step S5, the controller 13 converts the drawing area 23 into the drawing area 23a having the size suitable for the display image projected by the image display unit 11 as illustrated in FIG. 8. The drawing area 23 set in Step S4 is set with the coordinates in the front area image 20 and is unable to be used without change because the resolution of the display image projected by the image display unit 11 and the display range 24 are different. In this regard, the controller 13 converts the drawing area 23 into the coordinates of the drawing area 23a corresponding to the display image by enlarging the drawing area 23 on the basis of the resolution of the display image and the display range 24 and then moving it in parallel. For example, the controller 13 converts coordinates a1 (X1, Y1), a2 (X3, Y3), a3 (X5, Y5), b1 (X2, Y2), b2 (X4, Y4), and b3 (X6, Y6) indicating the drawing area 23 into coordinates a′1 (X′1, Y′1), a′2 (X′3, Y′3), a′3 (X′5, Y′5), b′1 (X′2, Y′2), b′2 (X′4, Y′4), and b′3 (X′6, Y′6) indicating the drawing area 23a. The coordinates indicating the converted drawing area 23a need not necessarily overlap the white lines 21a and 21b in a case in which the drawing area 23a is superimposed on the real landscape in front of the vehicle, but it is preferable that the drawing area 23a be not outside the white lines 21a and 21b in the width direction of the white lines 21a and 21b sandwiching the drawing area 23a. Further, in Step S5, the controller 13 finely adjusts the position of the drawing area 23a in accordance with the position of the eye point EP detected in Step S2.

In Step S6, as illustrated in FIG. 9, the controller 13 transforms the information image 25 including the route guidance information to the information image 25a in accordance with the shape of the drawing area 23a and renders the resulting information image. For example, in a case in which the information image 25 has a guide graphic 26 that guides a right direction, the guide graphic 26 is transformed to a guide graphic 26a having a depth in accordance with the shape of the drawing area 23a. Further, the controller 13 transforms the information image 25 in accordance with a change in the shape of the drawing area 23a in the display image.

In Step S7, the controller 13 corrects the distortion of the display image projected onto the windshield 104. Since the display image is distorted by the reflective mirror 14 of a curved surface shape and the curved windshield 104 which is arranged in the vehicle display device main body 4, the distortion of the display image is calculated on the basis of the position of the eye point EP detected in Step S2, and the distortion of the display image is reduced by distorting the image purposely. After Step S7 is completed, the process returns to Step S1, and the operation process is repeated.

As described above, the vehicle display device 1 according to the present embodiment includes the vehicle front side camera 2 that acquires the front area image 20 and the image analyzing unit 12 that detects the position of the white lines 21a and 21b and the position of the preceding vehicle 30 in a case in which there is a preceding vehicle 30 on the lane 22 from the front area image 20. The vehicle display device 1 further includes the controller 13 that sets the drawing area 23 on the lane 22 on the basis of the position of the white lines 21a and 21b or the position of the white lines 21a and 21b and the position of the preceding vehicle 30 and draws the information image 25 including the route guidance information in the drawing area 23a on the basis of the shape of the drawing area 23. The controller 13 transforms the information image 25 in accordance with the change in the shape of the drawing area 23a in the display image.

According to the vehicle display device 1 and the display control method of the present embodiment, it is possible to fixedly display the information to be notified to the driver D on the lane 22 at which the driver D is constantly looking. As a result, it is unnecessary for the driver D to search for guidance information displayed on the windshield 104, and it is possible to improve the safety when the driver D uses the HUD and the convenience of the HUD. Further, since the information image 25 is drawn in the drawing area 23a on the basis of the shape of the drawing area 23 and transformed in accordance with the change in the shape of the drawing area 23a, it is possible to display the information image 25a in accordance with the temporal change of the real landscape in front of the vehicle without overlapping the white lines 21a and 21b or the preceding vehicle 30, and it is possible to improve the conspicuousness of the route guidance information or the like.

Further, in the vehicle display device 1 according to the present embodiment, the controller 13 sets the drawing area 23 in the area which extends on the lane 22 along the white lines 21a and 21b from the area in front of the vehicle 100 without overlapping the preceding vehicle 30 on the basis of the coordinates indicating the position of the white lines 21a and 21b in the front area image 20 or the coordinates indicating the position of the white lines 21a and 21b, and the coordinates indicating the position of the preceding vehicle 30. Accordingly, it is possible to set the drawing area 23 on the lane 22 not to overlap the white lines 21a and 21b or the white lines 21a and 21b and the preceding vehicle 30. As a result, in addition to the above effects, it is possible to improve the conspicuousness of the information image 25a drawn in the drawing area 23a.

The vehicle display device 1 according to the present embodiment further includes the driver camera 3 that captures the driver D and acquires the driver image 40, the image analyzing unit 12 detects the position of the eye point EP of the driver D from the driver image 40, and the controller 13 adjusts the position of the drawing area 23a in the display image in accordance with the position of the eye point EP. Accordingly, in a case in which the position of the vehicle front side camera 2 is different from the position of the eye point EP of the driver D, it is possible to adjust the position of the drawing area 23a in accordance with the position of the eye point EP of the driver D, and it is possible to further improve the conspicuousness of the information image 25a drawn in the drawing area 23a.

### MODIFIED EXAMPLE

In the above embodiment, in a case in which an inter-vehicle distance between the vehicle 100 and the preceding vehicle 30 is short, a drawing area 23 with a necessary size is unable to be secured, and the conspicuousness of the information image 25a drawn in the drawing area 23a is likely to decrease. In this regard, transmittance of the entire information image 25a or the guide graphic 26a may be increased, and a part of the information image 25a may be displayed superimposed on the preceding vehicle 30. Further, in a case in which the information image 25 is drawn in the drawing area 23a on the basis of the shape of the drawing area 23a, the transformation of the information image 25 may not be performed in view of the conspicuousness of the information image 25a. In other words, in a case in which the guide graphic 26a is unable to be recognized although the information image 25 is transformed in accordance with the shape of the drawing area 23a, the information image 25 may be displayed without being transformed.

In the above embodiment, the information image 25a is drawn in the drawing area 23a regardless of the presence or absence of a road sign drawn on the lane 22, but the present embodiment is not limited thereto. For example, the image analyzing unit 12 may be configured to detect the road sign on the lane 22 from the front area image 20. Then, the controller 13 may be restricted not to set the drawing area 23 on the detected road sign in a case in which the road sign is detected on the lane 22.

In the above embodiment, the coordinates of the white lines 21a and 21b are located at the centers of the respective white lines 21a and 21b in the width direction (X axis direction) as illustrated in FIGS. 4, 5A, and 5B, but the present embodiment is not limited thereto as long as they are the positions capable of specifying the positions of the white lines 21a and 21b.

In the above embodiment, a pair of white lines 21a and 21b sandwiching the lane 22 is a white line, but the present embodiment is not limited thereto, and one of them may be a yellow line. Further, one of a pair of white lines 21a and 21b may be a solid line, and the other one may be a broken line. Further, one of a pair of white lines 21a and 21b may be two yellow solid lines. If the position of one of the white lines 21a and 21b is unable to be detected, the lane 22 may be specified using the position of the white line 21a or the white line 21b which is detected immediately before. Alternatively, the distance (lane width) in the X direction between one white line and the other white line may be specified as, for example, 3 m, and in a case in which the position of one white line is unable to be detected, the lane 22 may be specified by using the lane width. Here, the lane width is set to 3 m, but the present embodiment is not limited thereto, and the lane width may differ in accordance with a type of road (for example, a general national highway, an automobile expressway, or the like).

In the above embodiment, the vehicle front side camera 2 and the driver camera 3 are connected to the vehicle display device main body 4 via the communication lines 15 and 16 in a wired manner, respectively, but they may be wirelessly connected. Accordingly, or the communication lines 15 and 16 and a wiring work are unnecessary, and it is also possible to improve the restriction to the layout of the vehicle front side camera 2 and the driver camera 3.

In the above embodiment, the controller 13 acquires the route guidance information or the like from the navigation device 5 installed in the vehicle 100, but the present embodiment is not limited thereto. For example, the controller 13 may be configured to acquire the route guidance information or the like from the outside through wireless communication.

In the above embodiment, the route guidance information has been described as an example of the information to be informed to the driver D, but the information to be informed to the driver D may be, for example, vehicle speed information, vehicle state information, road information, external environment information, passenger information, or the like as long as the information is information for supporting the driving of the driver D.

According to the vehicle display device and the display control method of the present embodiments, there is the effect in that it is possible to fixedly display information to be informed to the driver at a position at which the driver is constantly looking.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device comprising:
an image display unit that projects a display image in front of a driver of a vehicle and causes the display image to be displayed superimposed on a real landscape in front of the vehicle;
a front area image acquiring unit that captures the real landscape in front of the vehicle and acquires a front area image;
a white line detecting unit that detects a position of a pair of colored lines sandwiching a lane extending to an area in front of the vehicle and a position of a preceding vehicle in a case in which there is a preceding vehicle on the lane from the front area image;
a area setting unit that sets a drawing area on the lane on the basis of the positions of the pair of colored lines or the positions of the pair of colored lines and the position of the preceding vehicle; and
a drawing unit that draws an information image including route guidance information to be informed to the driver in the drawing area on the basis of a shape of the drawing area, wherein
the drawing unit transforms the information image in accordance with a change in a shape of the drawing area in the display image.

2. The vehicle display device according to claim 1, wherein
the drawing area setting unit sets the drawing area in an area extending on the lane from the area in front of the vehicle along the colored line without overlapping the preceding vehicle on the basis of coordinates indicating the position of the colored line in the front area image or coordinates indicating the position of the colored line in the front area image and coordinates indicating the position of the preceding vehicle.

3. The vehicle display device according to claim 1, further comprising:
a driver image acquiring unit that captures the driver and acquires a driver image; and
an eye point detecting unit that detects a position of an eye point of the driver from the driver image, wherein
the drawing unit adjusts the position of the drawing area in the display image in accordance with the position of the eye point.

4. The vehicle display device according to claim 2, further comprising:
a driver image acquiring unit that captures the driver and acquires a driver image; and
an eye point detecting unit that detects a position of an eye point of the driver from the driver image, wherein
the drawing unit adjusts the position of the drawing area in the display image in accordance with the position of the eye point.

5. A display control method of a vehicle display device including an image display unit that projects a display image in front of a driver of a vehicle and causes the display image to be displayed superimposed on a real landscape in front of the vehicle, the display control method comprising:
a front area image acquisition step of capturing the real landscape in front of the vehicle and acquiring a front area image;
a white line detection step of detecting a position of a pair of colored lines sandwiching a lane extending to an area in front of the vehicle and a position of a preceding vehicle in a case in which there is a preceding vehicle on the lane from the front area image;
a drawing area setting step of setting a drawing area on the lane on the basis of the positions of the pair of colored lines or the positions of the pair of colored lines and the position of the preceding vehicle; and
a drawing step of drawing an information image including route guidance information to be informed to the driver in the drawing area on the basis of a shape of the drawing area, wherein
the drawing step includes transforming the information image in accordance with a change in a shape of the drawing area in the display image.
